(19) United States
(12) Patent Application Publication
(10) Pub. No.: US 2016/0156870 A1
(43) Pub. Date: Jun. 2, 2016

(54) SOLID-STATE IMAGING DEVICE

(71) Applicant: CANON KABUSHIKI KAISHA, Tokyo (JP)

(72) Inventor: Shin Kikuchi, Isehara-shi (JP)

(21) Appl. No.: 14/929,639

(22) Filed: Nov. 2, 2015

(30) Foreign Application Priority Data
Dec. 2, 2014 (JP) 2014-243744

(51) Int. Cl. H04N 5/3745; H04N 5/378

(52) U.S. Cl. CPC H04N 5/37457; H04N 5/37452; H04N 5/378

(57) ABSTRACT

A solid-state imaging device includes a plurality of pixels each including a photoelectric converting element and an amplifier unit for outputting a signal based on charges generated by the photoelectric converting element, a signal line connected to the plurality of pixels, a second line arranged at a position adjacent to the signal line, and a buffer unit connected to the signal line. The buffer unit buffers the signal at to the signal line, and outputs a signal having a same phase as that of the signal to the second line.

### BACKGROUND OF THE INVENTION

1. Field of the Invention

The present invention relates to a solid-state imaging device.

2. Description of the Related Art

In association with an increase in number of pixels of an imaging area of a solid-state imaging device and an enlargement of a photosensitive area, a technique for reading out a pixel signal at a higher speed is demanded. Japanese Patent Application Laid-Open No. 2013-243781 discloses such a technique that vertical signal lines connected to pixel columns are divided into two groups and pixel signals are read out in two directions, thereby reading out the pixel signals at a high speed. Japanese Patent Application Laid-Open No. 2001-251561 discloses such a technique that when a pixel signal temporarily held in a sample and hold capacitor is transferred to a horizontal signal line through a transfer switch, a parasitic capacitance of a horizontal signal line is controlled based on a level of the horizontal signal line, thereby suppressing a reduction of a signal amplitude.

However, according to the technique disclosed in Japanese Patent Application Laid-Open No. 2013-243781, although a parasitic capacitance of the vertical signal line can be reduced by dividing the vertical signal lines, since two signal processing circuits are necessary, a circuit area necessary for the signal processing circuits increases and their control also becomes complicated. Japanese Patent Application Laid-Open No. 2001-251561 relates to a technique for suppressing the reduction of the signal amplitude due to the capacitive division and nothing is disclosed about the read-out of the pixel from an amplifier unit to the vertical signal line.

### SUMMARY OF THE INVENTION

It is an aspect of the present invention to provide a solid-state imaging device which can read out a signal from an amplifier unit of a pixel to a signal line at a high speed.

According to an aspect of the present invention, there is provided a solid-state imaging device including a plurality of pixels each including a photoelectric converting element and an amplifier unit configured to output a signal based on charges generated by the photoelectric converting element, a signal line connected to the plurality of pixels, a second line arranged at a position adjacent to the signal line, and a buffer amplifier unit connected to the signal line and configured to buffer the signal at the signal line and output a signal having a same phase as that of the signal to the second line.

Further features of the present invention will become apparent from the following description of exemplary embodiments with reference to the attached drawings.

### BRIEF DESCRIPTION OF THE DRAWINGS

FIGS. 1A and 1B are schematic diagrams illustrating a construction of a solid-state imaging device according to a first embodiment of the present invention.

FIGS. 2A and 2B are perspective views each illustrating an example of a layout of guard lines in the solid-state imaging device according to the first embodiment of the present invention.

FIG. 3 is a diagram illustrating a circuit construction of an amplifying processing unit of the solid- state imaging device according to the first embodiment of the present invention.

FIG. 4 is a timing chart illustrating the operation of the solid-state imaging device according to the first embodiment of the present invention.

FIGS. 5A and 5B are diagrams illustrating a circuit construction of a buffer amplifier unit of a solid- state imaging device according to a second embodiment of the present invention.

FIG. 6 is a schematic diagram illustrating a construction of an imaging system according to a third embodiment of the present invention.

### DESCRIPTION OF THE EMBODIMENTS

Preferred embodiments of the present invention will now be described in detail hereinbelow in accordance with the accompanying drawings. In the diagrams of the embodiments, component elements having similar functions are designated by the same reference numerals and their description is omitted or simplified.

### First Embodiment

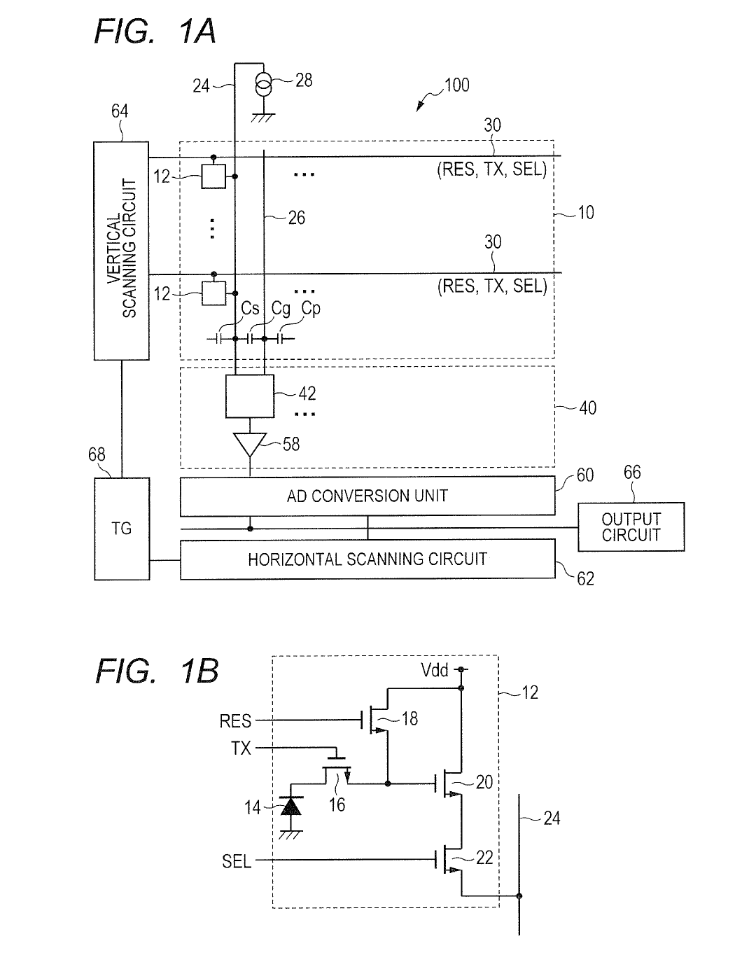

A solid-state imaging device according to a first embodiment of the present invention will be described hereinbelow with reference to FIGS. 1A to 4.

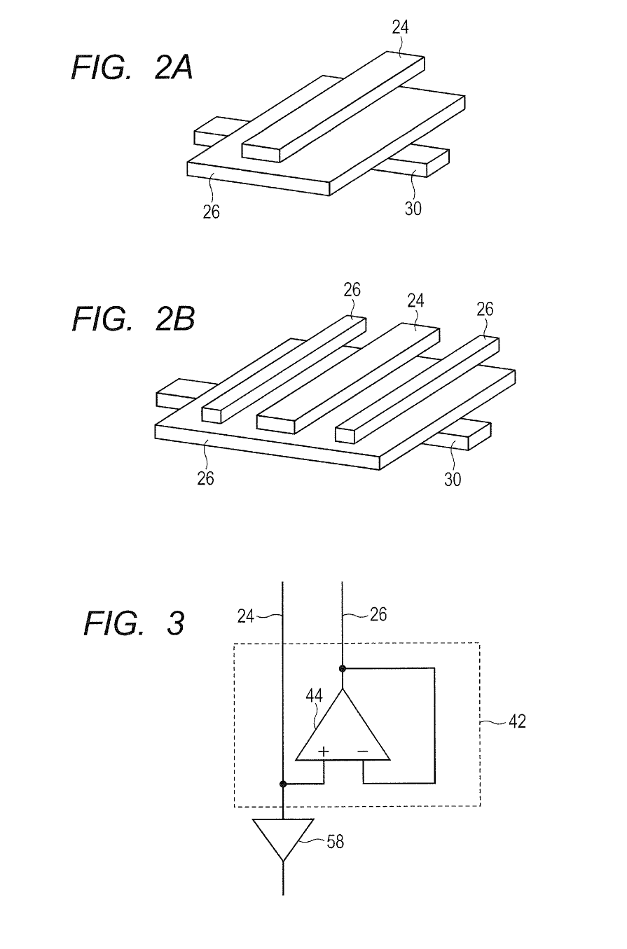

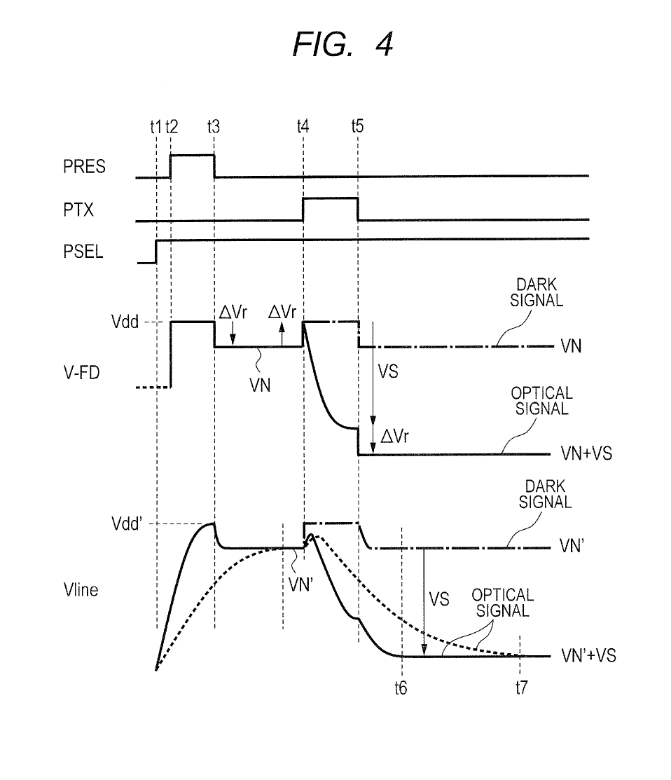

FIGS. 1A and 1B are schematic diagrams illustrating a construction of the solid-state imaging device according to the present embodiment. FIGS. 2A and 2B are perspective views each illustrating an example of a layout of guard lines in the solid-state imaging device according to the present embodiment. FIG. 3 is a diagram illustrating a circuit construction of an amplifying processing unit of the solid-state imaging device according to the present embodiment. FIG. 4 is a timing chart illustrating the operation of the solid-state imaging device according to the present embodiment.

First, a structure of the solid-state imaging device according to the present embodiment will be described with reference to FIGS. 1A to 3. FIG. 1A is a diagram illustrating a general construction of the solid-state imaging device according to the present embodiment. FIG. 1B is a diagram illustrating a circuit construction of a unit pixel of the solid-state imaging device according to the present embodiment.

As illustrated in FIG. 1A, a solid-state imaging device 100 according to the present embodiment has an imaging area 10, an amplifying processing unit 40, an AD conversion unit 60, a horizontal scanning circuit 62, a vertical scanning circuit 64, an output circuit 66, and a timing generator (TG) 68. The amplifying processing unit 40 is a signal processing unit for amplifying a pixel signal which is output from the imaging area 10 and outputting. The AD conversion unit 60 is a signal processing unit for converting the pixel signal as an analog signal into a digital signal. The amplifying processing unit 40 and the AD conversion unit 60 are a signal processing circuit for processing the pixel signal which is output from the imaging area 10. The horizontal scanning circuit 62 is a control circuit for controlling a transferring process at the time of outputting the digital signal converted by the AD conversion unit 60 to the output circuit 66. The vertical scanning circuit 64 is a control circuit for selecting and driving pixels in the imaging area 10 on a row unit basis. The TG 68 is a circuit for controlling timing for driving the whole solid-state imaging device 100. The output circuit 66 is a circuit for outputting the read-out signal to the signal processing unit of the solid-state imaging system.

A plurality of unit pixels 12 serving as imaging pixels are arranged in the imaging area 10 in a matrix form along the row direction and the column direction. For simplicity of the drawing, only the two unit pixels 12 arranged in the same column are illustrated in FIG. 1A. The number of unit pixels 12 arranged in the row direction and the column direction is not particularly limited. In this specification, it is assumed that the row direction denotes a lateral direction in the diagram and the column direction indicates a vertical direction in the diagram.

As illustrated in FIG. 1B, each of the unit pixels 12 has a photodiode 14, a transfer MOS transistor 16, a reset MOS transistor 18, an amplifier MOS transistor 20, and a select MOS transistor 22. An anode of the photodiode 14 is connected to a grounding voltage line and a cathode is connected to a source of the transfer MOS transistor 16. A drain of the transfer MOS transistor 16 is connected to a source of the reset MOS transistor 18 and a gate of the amplifier MOS transistor 20. A connecting node of the drain of the transfer MOS transistor 16, the source of the reset MOS transistor 18, and the gate of the amplifier MOS transistor 20 constitutes a floating diffusion node (hereinbelow, referred to as an “FD node”). A drain of the reset MOS transistor 18 and a drain of the amplifier MOS transistor 20 are connected to a power voltage line (voltage Vdd). A source of the amplifier MOS transistor 20 is connected to a drain of the select MOS transistor 22.

A driving signal line 30 is arranged in each row of the pixel array of the imaging area 10 so as to extend in the row direction. The driving signal line 30 functions as a signal line common to the unit pixels arranged in the row direction. The driving signal lines 30 are connected to the vertical scanning circuit 64. Predetermined driving signals to drive a pixel reading-out circuit of the unit pixels 12 are output from the vertical scanning circuit 64 to the driving signal line 30 at predetermined timing. Although a construction in which one driving signal line 30 is provided for each row is illustrated in FIG. 1A, typically, a plurality of driving signal lines are included in each row. A reset signal line RES connected to a gate of the reset MOS transistor 18, a transfer gate signal line TX connected to a gate of the transfer MOS transistor 16, and a select signal line SEL connected to a gate of the select MOS transistor 22 are included in the driving signal lines 30. It is not always necessary that those signal lines are arranged so as to extend in the row direction but a part of the signal lines may be arranged so as to extend in the column direction in accordance with the circuit construction or the like of the pixel reading-out circuit.

A vertical signal line, or a first line, 24 and a guard line, or a second line, 26 are arranged in each column of the pixel array of the imaging area 10 so as to extend in the column direction, respectively. The vertical signal line 24 is connected to a source of the select MOS transistor 22 of each of the unit pixels 12 arranged in the column direction. The vertical signal line 24 is a signal line common to those unit pixels 12. One end portion of the vertical signal line 24 is connected to the grounding voltage line via a current source 28.

As illustrated in FIGS. 2A and 2B, the guard line 26 is arranged between the driving signal line 30 and the vertical signal line 24 in close vicinity to the vertical signal line 24. In those examples, the guard line 26 is arranged at a position adjacent to the vertical signal line 24. FIG. 2A is an example in which the guard line 26 is constructed by an interconnection layer (for example, a first level metal interconnection layer) between an interconnection layer (for example, a gate layer) constructing the driving signal line 30 and an interconnection layer (for example, a second level metal interconnection layer) constructing the vertical signal line 24. FIG. 2B is an example in which the guard lines 26 constructed by the same interconnection layer as that of the vertical signal line 24 are further provided so as to sandwich the vertical signal line 24. Although the construction in which only one driving signal line 30 is provided in the lower layer of the vertical signal line 24 is illustrated in FIGS. 2A and 2B, a number of driving signal lines are arranged in the lower layer of the vertical signal line 24 in correspondence to the number of rows of the pixel array.

The amplifying processing unit 40 has a buffer amplifier unit 42, or a buffer unit 42, for reducing a read-out time of the pixel signal, and an amplifier unit 58 for executing a CDS process or an amplification gain process of the pixel signal. The buffer amplifier unit 42 and the amplifier unit 58 are provided in each column of the pixel array of the imaging area 10, respectively. As illustrated in FIG. 3, the buffer amplifier unit 42 includes an operational amplifier 44. The other end portion of the vertical signal line 24 is connected to a non-inverting input terminal (+) of the operational amplifier 44 and an input terminal of the amplifier unit 58. An inverting input terminal (−) of the operational amplifier 44 is connected to an output terminal of the operational amplifier 44. The guard line 26 is connected to the output terminal of the operational amplifier 44. Although the guard line 26 is connected to the unit pixels 12 via the buffer amplifier unit 42 and the vertical signal line 24, it is not directly connected to the unit pixels 12. The buffer amplifier unit 42 may be constructed by a source follower circuit.

The AD conversion unit 60 is connected to an output terminal of the amplifier unit 58. The horizontal scanning circuit 62 and the output circuit 66 are connected to the AD conversion unit 60. A predetermined control signal is input to the AD conversion unit 60 from the horizontal scanning circuit 62 at predetermined timing. The pixel signal output from the AD conversion unit 60 is sent to the output circuit 66 in response to the control signal.

Each of the horizontal scanning circuit 62 and the vertical scanning circuit 64 outputs a predetermined control signal synchronously with a timing signal output from the TG 68.

Subsequently, an outline of the operation of the solid-state imaging device according to the present embodiment will be described with reference to FIGS. 1A to 3.

When light enters the imaging area 10, signal charges are generated in the photodiode 14 serving as a photoelectric converting element by a photoelectric conversion. When the signal charges are transferred to the FD node via the transfer MOS transistor 16, they are converted into a voltage by a parasitic capacitance (FD capacitance) of the FD node. The voltage corresponding to the transferred signal charges is applied to the gate of the amplifier MOS transistor 20. When the select MOS transistor 22 is turned on in this state, a pixel source follower circuit is constructed by the amplifier MOS transistor 20, select MOS transistor 22, and current source 28. The amplified pixel signal is output to the vertical signal line 24. By sequentially selecting the rows of the pixel array of the imaging area 10 by the vertical scanning circuit 64 and reading out the pixel signals, the pixel signals of the unit pixels 12 can be sequentially output to the vertical signal line 24 on a row unit basis.

At this time, a read-out time of the pixel signal from the amplifier unit of the unit pixel 12 to the vertical signal line 24, that is, a time which is required until the charging of the signal voltage to the vertical signal line 24 is settled is influenced by the parasitic capacitances associated with the vertical signal line 24. Particularly, since a number of driving signal lines 30 are arranged so as to cross one vertical signal line 24, an influence which is exerted by the parasitic interconnection capacitor between the vertical signal line 24 and the driving signal line 30 is large.

In the construction in the related art in which the guard line 26 is not arranged between the vertical signal line 24 and the driving signal line 30, the parasitic interconnection capacitance between the vertical signal line 24 and the driving signal line 30 is very large. Since such a parasitic interconnection capacitor has a capacitance value larger than a parasitic capacitance Cs of the select MOS transistor 22, a long time is required to read out the signal from the unit pixel 12.

In order to realize the high-speed read-out of the pixel signal from the unit pixel 12 to the vertical signal line 24 as mentioned above, how to reduce the parasitic capacitances associated with the vertical signal line 24 is important.

In the solid-state imaging device of the present embodiment in which the guard line 26 is arranged between the vertical signal line 24 and the driving signal line 30, as illustrated in FIG. 1A, the parasitic capacitance Cs and a parasitic capacitance Cg exist for the vertical signal line 24 and a parasitic capacitance Cp exists for the guard line 26. In the parasitic capacitance Cs, the parasitic capacitance of the select MOS transistor 22 of the unit pixel 12 is a main component. The parasitic capacitance Cg is a parasitic interconnection capacitance between the vertical signal line 24 and the guard line 26. In the parasitic capacitance Cp, the parasitic capacitance between the unit pixel 12 and the driving signal line 30 is a main component.

In the solid-state imaging device according to the present embodiment, since the guard line 26 is arranged between the vertical signal line 24 and the driving signal line 30, the parasitic interconnection capacitance between the vertical signal line 24 and the driving signal line 30 can be suppressed. On the other hand, by providing the guard line 26, the parasitic capacitance Cg occurs between the vertical signal line 24 and the guard line 26. However, the parasitic capacitance Cg can be substantially reduced by feeding back the signal of the buffer amplifier unit 42 to the guard line 26.

In other words, for example, by connecting the vertical signal line 24 and the guard line 26 via the buffer amplifier unit 42 illustrated in FIG. 3, a pixel signal voltage Vline of the vertical signal line 24 is buffered by the buffer amplifier unit 42 and is input to the guard line 26. Thus, since a voltage of the vertical signal line 24 and a voltage of the guard line 26 change almost similarly, that is, at the same phase, a capacitance value of the parasitic capacitance Cg can be substantially remarkably reduced. Consequently, an influence by a voltage of the driving signal line 30 can be shielded by the guard line 26. By arranging the guard line 26, in the capacitance of the vertical signal line 24 serving as a load of the pixel source follower circuit, the parasitic capacitance Cs is a main component.

Therefore, in the load capacitance of the pixel source follower circuit constructed at the time of reading out the pixel signal, the parasitic capacitance Cs of the small capacitance value is a main component. A charge settling time of the vertical signal line 24 is shortened, that is, the pixel signal can be read out at a high speed.

FIG. 2A is an example in which the guard line 26 is arranged in a lower portion of the vertical signal line 24. FIG. 2B is an example in which the guard lines 26 are further arranged in side surface portions of the vertical signal line 24. As compared with the example of FIG. 2A, in the example of FIG. 2B, the parasitic interconnection capacitance of a capacitance value larger than the parasitic capacitance Cs can be further suppressed.

Subsequently, the specific operation of the solid-state imaging device according to the present embodiment will be described with reference to FIG. 4. In the following description, it is assumed that when each control signal is at the High level, the corresponding MOS transistor is set into a conductive state (ON) and, when it is at the Low level, the corresponding MOS transistor is set into a non-conductive state (OFF).

In FIG. 4, a signal PRES is a control signal for the reset MOS transistor 18 which is output from the vertical scanning circuit 64 to the reset signal line RES. A signal PTX is a control signal for the transfer MOS transistor 16 which is output from the vertical scanning circuit 64 to the transfer gate signal line TX. A signal PSEL is a control signal for the select MOS transistor 22 which is output from the vertical scanning circuit 64 to the select signal line SEL. A voltage V-FD is a voltage of the FD node. The voltage Vline is a voltage of the vertical signal line 24.

First, a transition of the voltage of the FD node associated with the reading operation of the pixel signal will be described. In the diagram, a waveform of a signal (optical signal) based on the signal charges is illustrated by a solid line and a waveform of a dark signal is illustrated by a one dot chain line.

At time t1, the signal PSEL is shifted from the Low level to the High level by the vertical scanning circuit 64 and the select MOS transistor 22 is turned on. Thus, the pixel source follower circuit enters the operative state.

Subsequently, at time t2, the signal RES is shifted from the Low level to the High level by the vertical scanning circuit 64 and the reset MOS transistor 18 is turned on. Thus, the FD node is reset to an initial state. That is, the FD node is charged to the voltage Vdd.

Subsequently, at time t3, the signal PRES is shifted from the High level to the Low level by the vertical scanning circuit 64 and the reset MOS transistor 18 is turned off. Since the reset MOS transistor 18 is turned off, the voltage V-FD changes by an amount of ΔVr due to a change in signal PRES. It is assumed that the voltage V-FD of the FD node at this time is a voltage VN. The voltage VN is a reference voltage of the unit pixel 12.

Subsequently, at time t4, the signal PTX is shifted from the Low level to the High level by the vertical scanning circuit 64 and the transfer MOS transistor 16 is turned on. Thus, the voltage V-FD rises by an amount of ΔVr due to a change in signal PTX. Electric charges Q which have been accumulated in the photodiode 14 and depend on a light reception amount are transferred to the FD node, so that the voltage V-FD decreases by an amount of a voltage VS obtained by dividing the charges Q by the FD capacitance. The voltage VN is a photoelectric conversion signal.

Subsequently, at time t5, the signal PTX is shifted from the High level to the Low level by the vertical scanning circuit 64 and the transfer MOS transistor 16 is turned off. Before the transfer MOS transistor 16 is turned off, the transfer of the charges from the photodiode 14 to the FD node has been finished. Since the FD capacitance is very small, the voltage change of the voltage V-FD is steep. Since the signal PTX is changed to OFF at time t5, the voltage V-FD changes by an amount of ΔVr, so that the voltage V-FD becomes (VN+VS).

After that, in a processing circuit at the post stage, a difference of the reference signal VN is calculated from the pixel signal (VN+VS) and the photoelectric conversion signal VS is obtained.

Subsequently, a transition of the voltage Vline of the vertical signal line 24 at the time when the voltage of the FD node has been read out to the vertical signal line 24 will be described. In the diagram, a waveform of the signal (optical signal) based on the signal charges is illustrated by a solid line and a waveform of the dark signal is illustrated by a one dot chain line. For comparison, a waveform of a signal (optical signal) based on the signal charges in the structure in the related art in which no guard line is provided is illustrated by a dotted line. Each voltage is shown by a reference character added with a quotation mark (′) in consideration of an offset voltage of the source follower circuit.

The read-out signal in the solid-state imaging device of the present embodiment illustrated by the solid line rapidly follows the change in voltage V-FD of the FD node and reaches (VN′+VS) at time t6 because the parasitic capacitance Cs of the vertical signal line 24 decreased by providing the guard line 26. On the other hand, the read-out signal in the solid-state imaging device of the structure in the related art illustrated by the dotted line reaches (VN′+VS) at time t7 because it takes a time until the charging is settled.

A time difference between time t6 and time t7 is a difference between the time which is required to read out the pixel signal of one pixel row in the solid-state imaging device according to the present embodiment and that in the solid-state imaging device of the structure in the related art. A value obtained by multiplying such a time difference by the number of pixel rows is a difference between the time which is required to read out the pixel signal of one frame of the image in the solid-state imaging device according to the present embodiment and that in the solid-state imaging device in the related art structure. According to the solid-state imaging device of the present embodiment, the photographing can be performed at a speed higher than that in the solid-state imaging device in the related art structure by an amount corresponding to such a time difference.

As mentioned above, according to the present embodiment, since the guard line is arranged between the vertical signal line and the driving signal line and the voltage of the same phase as that of the vertical signal line is output to this guard line, the parasitic capacitance associated with the vertical signal line can be substantially remarkably reduced. Thus, when the pixel signal is read out from the unit pixel to the vertical signal line, the charge settling time of the vertical signal line can be reduced and the pixel signal can be read out at a high speed.

### Second Embodiment

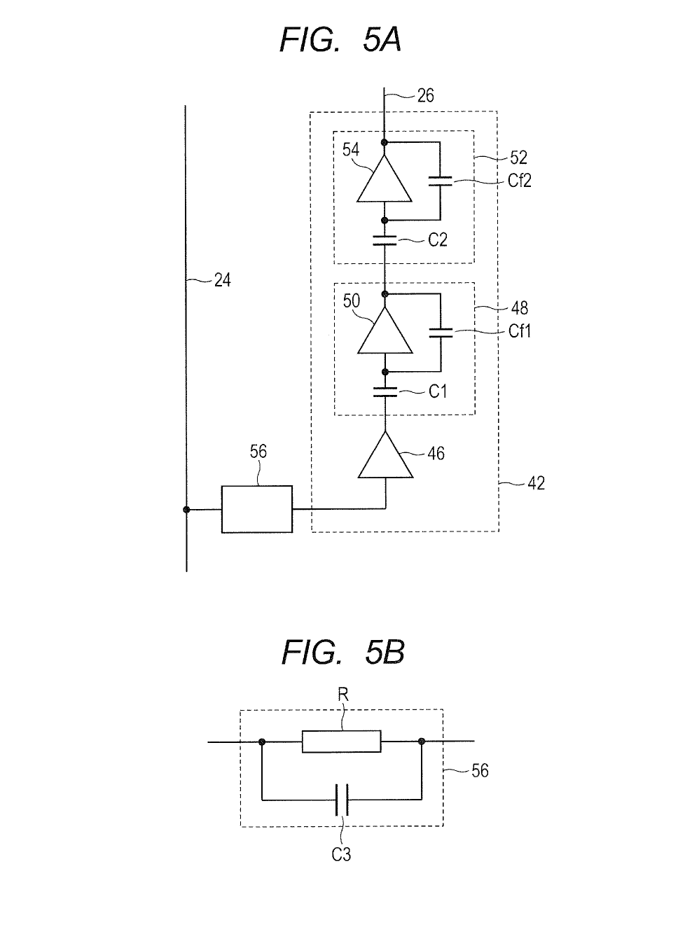

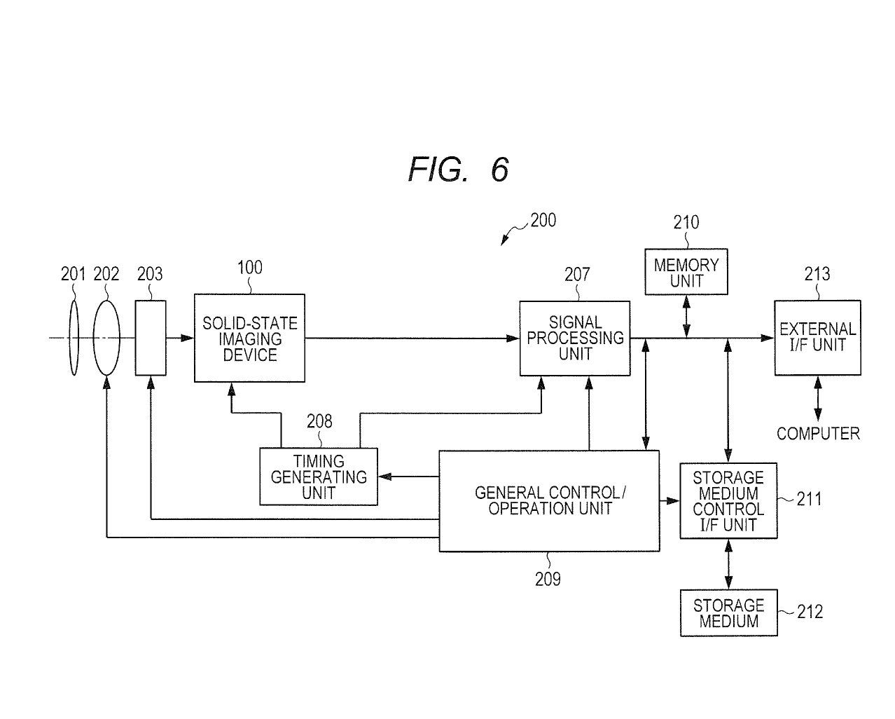

A solid-state imaging device according to a second embodiment of the present invention will be described hereinbelow with reference to FIGS. 5A and 5B. Component elements similar to those in the solid-state imaging device according to the first embodiment illustrated in FIGS. 1A to 4 are designated by the same reference numerals and their description is omitted or simplified.

FIGS. 5A and 5B are diagrams illustrating a circuit construction of the buffer amplifier unit 42 of the solid-state imaging device according to the present embodiment. FIG. 5A illustrates a connection relation between the general construction of the buffer amplifier unit 42 and signal lines. FIG. 5B illustrates an example of a construction of a high pass filter 56 connected to the buffer amplifier unit 42.

As illustrated in FIG. 5A, the buffer amplifier unit 42 of the solid-state imaging device according to the present embodiment has a buffer amplifier 46, an inverting amplifier 48, and an inverting amplifier 52. The inverting amplifier 48 has an operational amplifier 50, an input capacitor C1 connected to an input terminal of the operational amplifier 50, and a feedback capacitor Cf1 connected between the input terminal of the operational amplifier 50 and its output terminal. The inverting amplifier 52 has an operational amplifier 54, an input capacitor C2 connected to an input terminal of the operational amplifier 54, and a feedback capacitor Cf2 connected between the input terminal of the operational amplifier 54 and its output terminal.

An input terminal of the buffer amplifier 46 is connected to the vertical signal line 24 and an output terminal is connected to the input terminal of the operational amplifier 50 via the input capacitor C1. The output terminal of the operational amplifier 50 is connected to the input terminal of the operational amplifier 54 via the input capacitor C2. The output terminal of the operational amplifier 54 is connected to the guard line 26.

The high pass filter 56 may be provided between the vertical signal line 24 and the buffer amplifier 46 or between the inverting amplifier 52 and the guard line 26. FIG. 5A illustrates an example in which the high pass filter 56 is provided between the vertical signal line 24 and the buffer amplifier 46. FIG. 5B illustrates an example of a construction of the high pass filter 56. The high pass filter 56 illustrated in FIG. 5B is constructed by connecting a resistor R and a capacitor C3 in parallel.

In the buffer amplifier unit 42 of the solid-state imaging device according to the present embodiment, in order to improve a degree of setting freedom of a feedback ratio, a non-inverting construction is realized by the buffer amplifier 46 and the two inverting amplifiers 48 and 52. The buffer amplifier 46 may be replaced by a source follower circuit.

Since an amplification factor (gain) of the inverting amplifier 48 is equal to a ratio C1/Cf1 between the capacitance values of the input capacitor C1 and the feedback capacitor Cf1, if their capacitance values are set to Cf1≧C1, the gain can be set to not more than 1. Similarly, a gain of the inverting amplifier 52 is equal to a ratio C2/Cf2 between the capacitance values of the input capacitor C2 and the feedback capacitor Cf2, if their capacitance values are set to Cf2 C2, the gain can be set to not more than 1. By properly changing those parameters, a feedback ratio can be freely set in accordance with the number of pixels, a pixel size, a size of the pixel source follower circuit, and the like.

As described in the first embodiment, by providing the buffer amplifier unit 42 and the guard line 26 so as to be connected to the vertical signal line 24, the parasitic capacitance of the vertical signal line 24 is reduced and the high-speed read-out operation can be realized. The high pass filter 56 has such an effect that the read-out time can be further shortened.

The parasitic capacitance Cg between the vertical signal line 24 and the guard line 26 becomes minimum when the voltage which is read out from the pixel source follower circuit to the vertical signal line 24 and the voltage obtained by feeding back such a voltage to the guard line 26 by the buffer amplifier unit 42 are equal. However, there is a case where a delay occurs by the buffer amplifier unit 42 serving as a feedback path and the parasitic capacitance (Cg+Cp) of the guard line 26, thereby obstructing the high speed operation.

Therefore, the high pass filter 56 is provided between the vertical signal line 24 and the guard line 26, thereby emphasizing a high frequency component of a voltage change (transient characteristics) of the vertical signal line 24. By using such a structure, the influence of the parasitic capacitance as a factor of the obstruction of the high speed operation is suppressed and the feedback operation can be performed at a high speed.

As mentioned above, according to the present embodiment, since the feedback ratio of the buffer amplifier unit 42 can be freely set, the invention can be widely applied to solid-state imaging devices in which the numbers of pixels, pixel sizes, sizes of the pixel source follower circuits, and the like differ, respectively. By providing the high pass filter 56, the further high-speed read-out operation can be realized.

### Third Embodiment

An imaging system according to a third embodiment of the present invention will be described with reference to FIG. 6.

FIG. 6 is a schematic diagram illustrating an example of a construction of the imaging system according to the present embodiment. Component elements similar to those in the solid-state imaging devices according to the first and second embodiments illustrated in FIGS. 1A to 5B are designated by the same reference numerals and their description is omitted or simplified.

An imaging system 200 according to the present embodiment can be applied to, for example, a digital still camera, a digital camcorder, a camera head, a copying apparatus, a facsimile apparatus, a cellular phone, an onboard camera, an observation satellite, and the like although it is not particularly limited.

The imaging system 200 has the solid-state imaging device 100, a lens 202, an aperture 203, a barrier 201, a signal processing unit 207, a timing generating unit 208, a general control/operation unit 209, a memory unit 210, a storage medium control I/F unit 211, and an external I/F unit 213.

The lens 202 is provided to focus an optical image of an object onto the solid-state imaging device 100. The aperture 203 is provided to vary an amount of light which passed through the lens 202. The barrier 201 is provided to protect the lens 202. The solid-state imaging device 100 is the solid-state imaging device which has already been described in each of the foregoing embodiments and is provided to convert the optical image focused by the lens 202 into image data.

The signal processing unit 207 executes processes for performing various kinds of corrections and a data compression to the imaging data output from the solid-state imaging device 100. An AD conversion unit for AD converting the image data may be mounted on the same substrate as that of the solid-state imaging device 100 or may be mounted on a different substrate. Similarly, the signal processing unit 207 may be also mounted on the same substrate as that of the solid-state imaging device 100 or may be mounted on a different substrate. The timing generating unit 208 is provided to output various kinds of timing signals to the solid-state imaging device 100 and the signal processing unit 207. The general control/operation unit 209 is provided to control the whole imaging system. The timing signals and the like may be input from the outside of the imaging system 200. It is sufficient that the imaging system has at least the solid-state imaging device 100 and the signal processing unit 207 for processing the imaging signal output from the solid-state imaging device 100.

The memory unit 210 is a frame memory unit for temporarily storing the image data. The storage medium control I/F unit 211 is an interface unit for recording the image data into a storage medium 212 or reading out the image data from the storage medium 212. The storage medium 212 is a detachable recording medium such as a semiconductor memory or the like for recording or reading out the image pickup data. The external I/F unit 213 is an interface unit for communicating with an external computer or the like.

By constructing the imaging system to which the solid-state imaging device according to each of the first and second embodiments is applied as mentioned above, the imaging system which can photograph at a high speed can be realized.

[Modifications]

The present invention is not limited to the foregoing embodiments but many various modifications are possible.

For example, although the solid-state imaging device in which the driving signal line 30 is arranged on the lower layer side than the vertical signal line 24 has been described as an example in the foregoing embodiments, it is not always necessary that the driving signal line 30 is located on the lower layer side than the vertical signal line 24. The driving signal line 30 may be arranged on the upper layer side than the vertical signal line 24. A part of the driving signal line 30 may be arranged on the lower layer side than the vertical signal line 24 and another part may be arranged on the upper layer side than the vertical signal line 24. When the driving signal line 30 is arranged on the upper layer side than the vertical signal line 24, by arranging the guard line 26 between the vertical signal line 24 and the driving signal line 30, an effect similar to that described in the foregoing embodiments can be obtained.

Although the driving signal line 30 of the pixel reading-out circuit has been shown as an example of the interconnection layer in which the parasitic capacitance which becomes an obstacle of the high-speed read-out operation is formed between the vertical signal line 24 and the driving signal line 30 in the foregoing embodiments, it is not always necessary to be the driving signal line 30. In this case, by arranging the guard line 26 between the vertical signal line 24 and the interconnection layer in which the parasitic capacitance which becomes an obstacle of the high-speed read-out operation is formed between the vertical signal line 24 and the interconnection layer, an effect similar to that described in the foregoing embodiments can be obtained.

The construction of the unit pixel 12 illustrated in FIG. 1B has been shown as an example. The construction of the unit pixel 12 which can be applied to the solid-state imaging device according to the present invention is not limited to such a construction.

The imaging system shown in the third embodiment is an example of the imaging system to which the solid-state imaging device of the present invention can be applied. The imaging system to which the solid-state imaging device of the present invention can be applied is not limited to the construction illustrated in FIG. 6.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-243744, filed on Dec. 2, 2014, which is hereby incorporated by reference herein in its entirety.

What is claimed is:

1. A solid-state imaging device comprising:
a plurality of pixels each including a photoelectric converting element and an amplifier unit configured to output a signal based on charges generated by the photoelectric converting element;
a signal line connected to the plurality of pixels;
a second line arranged at a position adjacent to the signal line; and
a buffer unit connected to the signal line and configured to buffer the signal at the signal line and output a signal having a same phase as that of the signal at the signal line to the second line.

2. The solid-state imaging device according to claim 1, wherein
the second line is arranged between the signal line and a driving signal line to drive the pixel.

3. The solid-state imaging device according to claim 1, wherein
the buffer unit includes at least two inverting amplifiers.

4. The solid-state imaging device according to claim 1, wherein
the buffer unit includes a source follower circuit or an operational amplifier.

5. The solid-state imaging device according to claim 1, wherein
a gain of the buffer unit is not more than 1.

6. The solid-state imaging device according to claim 1, wherein
the buffer unit has a high pass filter at an input or at an output.

7. The solid-state imaging device according to claim 2, wherein
the signal line and the second line are arranged so as to extend in a first direction; and
the driving signal line is arranged so as to extend in a second direction which crosses the first direction.

8. The solid-state imaging device according to claim 1, further comprising:
a signal processing circuit configured to process the signal output to the signal line.

9. A solid-state imaging device comprising:
a plurality of pixels each including a photoelectric converting element and an amplifier unit configured to output a signal based on charges generated by the photoelectric converting element;
a signal line connected to the plurality of pixels;
a second line arranged at a position adjacent to the signal line; and
a buffer unit including an input connected to the signal line and an output connected to the second line.

10. An imaging system comprising:
a solid-state imaging device including a plurality of pixels each including a photoelectric converting element and an amplifier unit configured to output a signal based on charges generated by the photoelectric converting element, a signal line connected to the plurality of pixels, a second line arranged at a position adjacent to the signal line, and a buffer unit connected to the signal line and configured to buffer the signal at the signal line and output a signal having a same phase as that of the signal at the signal line to the second line; and
a signal processing apparatus configured to process the signal output from the solid-state imaging device.
